(19) United States
(12) Patent Application Publication
(10) Pub. No.: US 2024/0304046 A1
(43) Pub. Date: Sep. 12, 2024

(54) SYSTEM AND METHOD FOR FACILITATING VEHICLE INSPECTION

(71) Applicant: Trip Inspection Commercial Assistant LLC, TUCSON, AZ (US)

(72) Inventors: Roberto Carranza, TUCSON, AZ (US); Elvira Leticia Carranza, TUCSON, AZ (US)

(73) Assignee: Trip Inspection Commercial Assistant LLC, TUCSON, AZ (US)

(21) Appl. No.: 18/182,169

(22) Filed: Mar. 10, 2023

(51) Int. Cl. G07C 5/10; G06K 7/14

(52) U.S. Cl. CPC G07C 5/10; G06K 7/1413; G07C 2205/02

(57) ABSTRACT

A method to facilitate vehicle inspection is described. The method may include obtaining first scan information and second scan information from a user device. The first scan information may be associated with a first barcode disposed at a vehicle first component and the second scan information may be associated with a second barcode disposed at a vehicle second component. The method may further include determining a first authenticity score for the first scan information and a second authenticity score for the second scan information. The method may include transmitting a request to the user device to provide additional information when the first authenticity score or the second authenticity score may be less than a threshold, or transmitting an inspection completion notification to the user device when the first authenticity score and the second authenticity may be greater than the threshold.

### TECHNICAL FIELD

The present disclosure relates to a system and method for facilitating vehicle inspection, and more particularly, to a system and method for facilitating vehicle inspection by a user device and authenticating the inspection.

### BACKGROUND

Commercial vehicle operators may be required to perform pre-trip and post-trip vehicle inspections, and fill electronic daily vehicle inspection reports (eDVIRs). For example, the operators may need to inspect vehicle tires, fuel system, lights, brakes, etc., and record inspection outcome. Such inspections may help in identifying issues associated with vehicle components, and may hence facilitate in planning vehicle maintenance.

While such regular inspections may provide benefits to an operator, there may be instances where the operator may inadvertently or intentionally skip an inspection for a vehicle. For example, the operator may skip the inspection due to lack of time, and/or may fill the eDVIR without actually performing the inspection. Such instances may cause inconvenience to operators who may use the vehicle in future trips, especially if one or more vehicle components develop a fault.

Thus, there exists a need for an inspection system that may facilitate execution of vehicle inspection and verification of inspection authenticity.

It is with respect to these and other considerations that the disclosure made herein is presented.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an example vehicle inspection system in accordance with the present disclosure.

FIG. 3 depicts example snapshots of a user interface in accordance with the present disclosure.

FIG. 4 depicts a flow diagram of an example first vehicle inspection method in accordance with the present disclosure.

FIG. 5 depicts a flow diagram of an example second vehicle inspection method in accordance with the present disclosure.

### DETAILED DESCRIPTION

### Overview

The present disclosure describes a system and method to facilitate pre-trip and post-trip vehicle inspection. A user (e.g., a vehicle operator) may manually perform the pre-trip and post-trip inspection of various vehicle components, and may scan quick response (QR) codes disposed on the vehicle components by using a user device. The user device may transmit individual scan information to the system to indicate that the user may have completed inspection of individual vehicle components. The system may obtain the individual scan information from the user device, and may authenticate the scan information. In some aspects, the system may request for additional information associated with one or more vehicle components when the system determines that the obtained scan information may not be authentic. Alternatively, the system may transmit a vehicle inspection completion notification to the user device when the system determines that the obtained scan information may be authentic.

In some aspects, the system may obtain the scan information associated with various vehicle components in a sequential order. For example, the system may transmit a request to the user device to provide scan information for a vehicle first component, and then provide scan information for a vehicle second component, and so on. The user device may provide scan information in the sequential order based on the request received from the system.

In further aspects, the system nay determine scan authenticity by calculating authentication scores for individual scan information, and comparing the authentication scores with a predefined threshold. The system may determine a scan to be unauthentic when corresponding authentication score may be less than the predefined threshold. In an exemplary aspect, the system may determine the authentication scores based on time gap between obtaining successive scan information. In another aspect, the system may determine authentication scores based on user device orientation and/or location when the user scans the QR codes.

The present disclosure discloses a system and method that facilitates inspection of vehicle components. Specifically, the system authenticates scan information transmitted by the user device, and ensures that the user inspects the vehicle components before commencing a trip or after completing the trip. Thus, the system prevents user inconvenience during the trip, and also facilitates road safety.

These and other advantages of the present disclosure are provided in detail herein.

### Illustrative Embodiments

The disclosure will be described more fully hereinafter with reference to the accompanying drawings., in which example embodiments of the disclosure are shown, and not intended to be limiting.

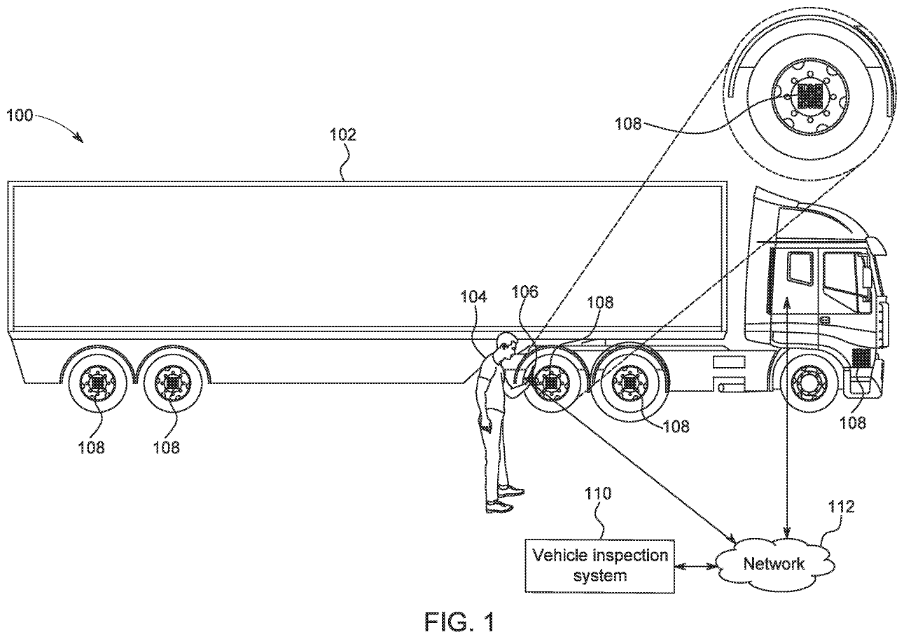

FIG. 1 depicts an example environment 100 in which techniques and structures for providing the systems and methods disclosed herein may be implemented. The environment 100 may include a vehicle 102, a vehicle operator 104, and a user device 106. In some aspects, the vehicle operator 104 may be performing vehicle inspection. The vehicle operator 104 may perform the vehicle inspection before the vehicle operator 104 starts a trip or after the vehicle operator 104 completes a trip. The vehicle operator 104 may additionally fill electronic daily vehicle inspection report (eDVIR) when the vehicle operator 104 performs the vehicle inspection.

The vehicle 102 may take the form of any commercial vehicle such as, for example, pickup truck, box truck, van, bus, taxi, trailers, etc. Further, the vehicle 102 may include any powertrain such as, for example, a gasoline engine or diesel engine, one or more electrically-actuated motor(s), a hybrid system, etc. Furthermore, the vehicle 102 may be a manually driven vehicle and/or be configured and/or programmed to operate in a fully autonomous (e.g., driverless) mode or in one or more partial autonomy modes which may include driver assist technologies.

The vehicle 102 may include a plurality of unique identifiers that may be disposed at different vehicle components. For example, the vehicle 102 may include a first identifier disposed at a vehicle light, a second identifier disposed at a vehicle fuel system, a third identifier at a driver side front tire rim, and/or the like. The plurality of unique identifiers may be, for example, quick response (QR) codes (e.g., QR codes 108, shown in FIG. 1). In other aspects, the unique identifiers may be associated with other types of barcodes, e.g., Universal Product Codes (UPC), Data Matrix, and/or the like.

The user device 106 may be a communication device, such as a mobile phone, a smart phone, a mobile node, a smart watch, a scanner, a personal digital assistant (PDA), a tablet computer, a laptop computer, or any other similar device with communication capabilities.

The environment 100 may further include a vehicle inspection system 110. The vehicle 102 and/or the user device 106 associated with the vehicle operator 104 may communicatively couple with the vehicle inspection system 110 via a network 112. The vehicle inspection system 110 may be hosted on a server (e.g., cloud).

The network 112 may be, for example, a communication infrastructure in which the connected devices discussed in various embodiments of this disclosure may communicate. The network 112 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), to name a few examples.

In operation, the vehicle operator 104 may manually inspect one or more vehicle components and scan QR codes/barcodes 108 disposed at respective vehicle components by using the user device 106, when the inspection of respective vehicle components is complete. Responsive to scanning the QR code(s) 108, the user device 106 may transmit scan information (associated with the QR code(s) 108) to the vehicle inspection system 110 via the network 112. The vehicle inspection system 110 may receive the scan information, and may determine scan authenticity of the scan information. In addition, the vehicle inspection system 110 may determine whether the vehicle operator 104 has inspected all vehicle components.

The vehicle inspection system 110 may transmit an inspection completion notification to the user device 106 when the vehicle inspection system 110 determines that the scans are authentic, and/or the vehicle operator 104 has scanned all vehicle components. In some aspects, the vehicle inspection system 110 may transmit a request to re-scan one or more vehicle components when the vehicle inspection system 110 determines that the scan may not be authentic. (00261 As an example, the vehicle operator 104 may manually inspect a driver side front tire (e.g., to check if the tire may be flat), and scan a first barcode associated with the driver side front tire by using the user device 106 to indicate to the vehicle inspection system 110 that the vehicle operator 104 has inspected the driver side front tire. The vehicle operator 104 may then move towards vehicle 102 front portion, manually inspect vehicle 102 front light (e.g., to check if the light may be working or in faulty condition), and scan a second barcode associated with the vehicle 102 front light to indicate vehicle 102 front light inspection. The vehicle operator 104 may then move towards passenger side, inspect passenger side front tire, and may scan a third barcode associated with the passenger side front tire. The vehicle operator 104 may perform the same process for all vehicle components to be checked. A person ordinarily skilled in the art may appreciate that the vehicle operator 104 may be required to physically move around the vehicle 102 when the vehicle operator 104 manually inspects and scans the QR codes/barcodes 108 disposed at different vehicle components.

In some aspects, the user device 106 may sequentially transmit scanned information associated with the first barcode, the second barcode and the third barcode to the vehicle inspection system 110. In an exemplary aspect, the vehicle inspection system 110 may transmit instructions to the user device 106 indicating an order of inspection, and the vehicle operator 104 may inspect the vehicle components based on inspection order received from the vehicle inspection system 110. For example, the vehicle inspection system 110 may request the vehicle operator 104 to inspect vehicle 102 front light first, then inspect driver side front tire, and so on.

In other aspects, the user device 106 may transmit scanned information associated with the first barcode, the second barcode and the third barcode simultaneously to the vehicle inspection system 110 when the vehicle operator 104 scans the QR codes/barcodes 108 associated with all vehicle components.

The vehicle inspection system 110 may receive the scanned information from the user device 106, and determine whether the scans may be authentic and/or the vehicle operator 104 may have scanned all vehicle components based on the received scanned information. In some aspects, the vehicle inspection system 110 may determine scan authenticity as and when the respective scan information may be received. For example, the vehicle inspection system 110 may determine the authenticity of scan information associated with the first barcode, and then determine the authenticity of scan information associated with the second barcode when the scan information of the first barcode and the second barcode may be received in sequence. In some aspects, the vehicle inspection system 110 may not allow the vehicle operator 104 to scan the second barcode or transmit scan information associated with the second barcode to the vehicle inspection system 110 when the vehicle inspection system 110 determines that the scan information associated with the first barcode may be not authentic. In further aspects, the vehicle inspection system 110 may determine scan authenticity when all the scan information, for example, scan information associated with the first barcode, the second barcode, and the third barcode may be received.

In one exemplary aspect, the vehicle inspection system 110 may determine authenticity of a scan (e.g., associated with the second barcode) based on a time gap between obtaining the scan information associated with the second barcode and scan information associated with a previously-scanned barcode (e.g., the first barcode). The vehicle inspection system 110 may determine that the scan may not be authentic when the time gap is less than (or greater than) a predefined threshold.

In another exemplary aspect, the vehicle inspection system 110 may determine authenticity of a scan (e.g., associated with the second barcode) based on user device 106 orientation (e.g., determined via an Inertial Measurement Unit (IMU) present in the user device 106) when the vehicle operator 104 scans the second barcode. The vehicle inspection system 110 may determine that the scan may not be authentic if the user device 106 orientation is different from “expected” user device 106 orientation while scanning the second barcode. For example, if the vehicle operator 104 scans a barcode disposed on vehicle tire, however the user device 106 orientation indicates that the user device 106 may be directed towards vehicle top surface, the vehicle inspection system 110 may determine that the scan may not be authentic.

In a similar manner, the vehicle inspection system 110 may determine scan authenticity for the second barcode based on user device 106 location when the vehicle operator 104 scans the second barcode.

In further aspects, the vehicle inspection system 110 may be configured to provide “authenticity scores” to the scans performed by the vehicle operator 104 via the user device 106, based on the received scan information. In addition, the vehicle inspection system 110 may generate instructions to provide additional information when an authenticity score associated with a scan is less than a threshold value. For example, the vehicle inspection system 110 may generate instructions requesting the user device 106 to provide images of a vehicle first component when an authenticity score associated with a barcode scan of the vehicle first component may be less than the threshold value.

On the other hand, responsive to determining that the scan information associated with all barcodes (e.g., the first barcode, the second barcode and the third barcode) may be authentic, the vehicle inspection system 110 may transmit an inspection completion notification to the user device 106.

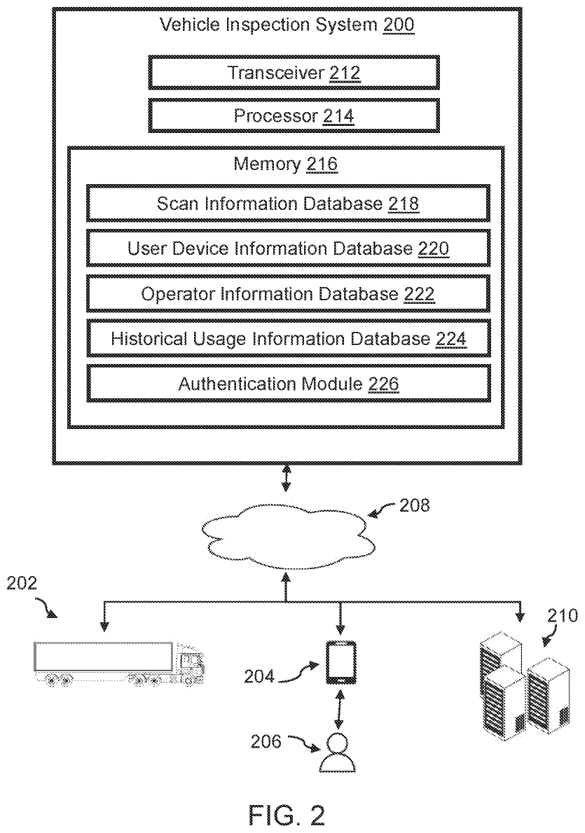

These and other aspects of the present disclosure are described in detail in conjunction with FIG. 2.

In additional aspects, along with transmitting scan information, the vehicle operator 104 may transmit vehicle component fault notification to the vehicle inspection system 110, if a specific vehicle component may be faulty. Responsive to receiving the vehicle component fault notification, the vehicle inspection system 110 may schedule vehicle maintenance to repair the faulty vehicle component.

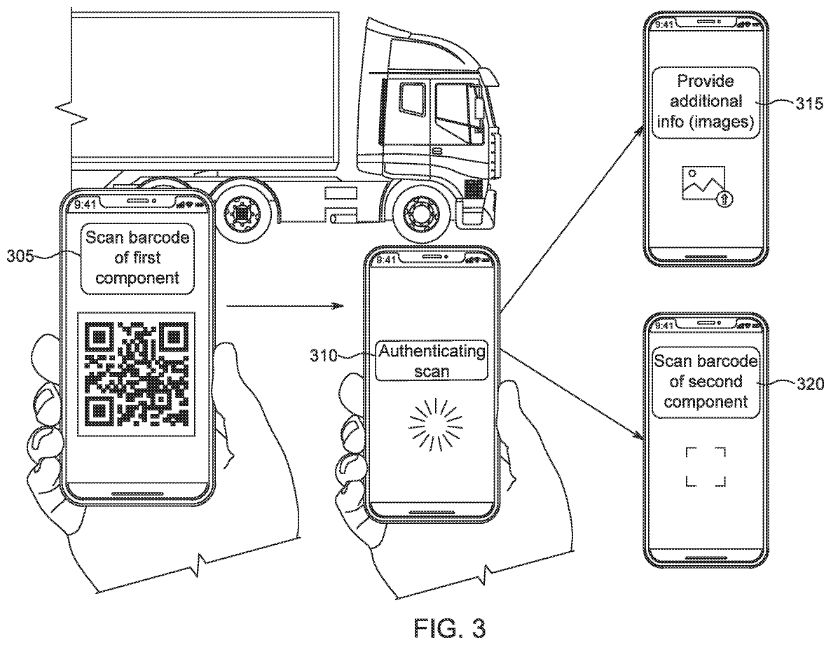

FIG. 2 depicts a block diagram of an example vehicle inspection system 200 (“system 200”) in accordance with the present disclosure. While describing FIG. 2, references may be made to FIG. 3. FIG. 3 depicts example snapshots of a user interface in accordance with the present disclosure.

The system 200 may be same as the vehicle inspection system 110, and may communicatively couple with a vehicle 202 and a user device 204 (associated with a user 206) via a network 208. The user 206 may be associated with the vehicle 202. The vehicle 202 may be same as the vehicle 102, and the network 208 may be same as the network 112. The user device 204 may be, for example, a mobile phone, a laptop, a computer, a tablet, or a similar device with communication capabilities.

The system 200 may further communicatively couple with one or more servers 210 (or a server 210) via the network 208. The server 210 may be part of a cloud-based computing infrastructure, and may be associated with and/or include a Telematics Service Delivery Network (SDN) that provides digital data services to the vehicle 202, and other vehicles (not shown in FIG. 2). In an exemplary aspect, the server 210 may be associated with a navigation service provider and may provide navigation services to the vehicle 202 and the user device 204.

In some aspects, the system 200 may be an application (“app”) that may be hosted on one or more distributed computing devices and/or a server (e.g., the server 210). Further, although FIG. 2 depicts that the system 200 is communicatively connected with the vehicle 202 and the user device 204, a person ordinarily skilled in the art may appreciate that the system 200 may communicatively couple with a plurality of vehicles and user devices simultaneously.

The system 200 may include one or more components or units including, but not limited to, a transceiver 212, a processor 214, and a memory 216. The transceiver 212 may be configured to communicate with external devices via the network 208. For example, the transceiver 212 may receive data or information, including scan information associated with the QR codes 108 disposed at one or more vehicle 202 components from the user device 204, via the network 208. The transceiver 212 may also receive additional information from the user device 204 including, but not limited to, user device orientation, user device location, vehicle component images, and/or the like. Further, the transceiver 212 may receive navigation information, e.g., navigation maps, from the server 210. In a similar manner, the transceiver 212 may transmit data or information, including inputs, instructions, requests, and/or the like, to the vehicle 202 and/or the user device 204. 00421 In some aspects, the memory 216 may store programs in code and/or store data for performing various system 200 operations in accordance with the present disclosure. Specifically, the processor 214 may be configured and/or programmed to execute computer-executable instructions stored in the memory 216 for performing various system 200 functions in accordance with the disclosure. Consequently, the memory 216 may be used for storing code and/or data code and/or data for performing operations in accordance with the present disclosure.

In one or more aspects, the processor 214 may be disposed in communication with one or more memory devices (e.g., the memory 216 and/or one or more external databases (not shown in FIG. 2)). The memory 216 can include any one or a combination of volatile memory elements (e.g., dynamic random-access memory (DRAM), synchronous dynamic random access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

The memory 216 may be one example of a non-transitory computer-readable medium and may be used to store programs in code and/or to store data for performing various operations in accordance with the disclosure. The instructions in the memory 216 can include one or more separate programs, each of which can include an ordered listing of computer-executable instructions for implementing logical functions.

In some aspects, the memory 216 may include a plurality of modules and databases including, but not limited to, a scan information database 218, a user device information database 220, an operator information database 222, a historical usage information database 224, and an authentication module 226. The authentication module 226, as described herein, may be stored in the form of computer-executable instructions, and the processor 214 may be configured and/or programmed to execute the stored computer-executable instructions for performing system 200 functions in accordance with the present disclosure. The functions of the plurality of databases and modules included in the memory 216 are described later in the description below.

In operation, the user 206 may use the user device 204 and scan barcodes (e.g., the QR codes 108) disposed at different vehicle components. As described in conjunction with FIG. 1, in some aspects, the user 206 may scan the vehicle components in a predefined order (e.g., in a scan order instructed by the system 200). In other aspects, the user 206 may scan the vehicle components in any order (i.e., not in any predefined order).

The user 206 may further transmit scan information to the transceiver 212, via the user device 204. In some aspects, the user 206 may transmit scan information simultaneously for scans associated with all vehicle components when the user 206 completes the manual inspection and scans for all vehicle components. In other aspects, the user may transmit scan information sequentially. For example, the user 206 may scan a first barcode disposed at a vehicle first component (e.g., a vehicle front tire), and transmit scan information associated with the first barcode to the transceiver 212. The user 206 may then scan a second barcode disposed at a vehicle second component (e.g., a vehicle front light, located in proximity to the vehicle first component), and transmit scan information associated with the second barcode to the transceiver 212, until all vehicle components to be inspected are manually inspected by the user 206 and corresponding scan information is transmitted to the transceiver 212.

The transceiver 212 may receive the scan information associated with the first barcode, the second barcode, etc. (sequentially or simultaneously) from the user device 204, and may store the scan information in the scan information database 218 (and/or in the server 210) The processor 214 may obtain the scan information from the memory 216 or from the transceiver 242. Responsive to obtaining the scan information, the processor 214 may determine authenticity of the each scan individually (e.g., to confirm whether the user 206 actually performed the inspection). The processor 214 may approve the scan based on determined authenticity, or may request the user device 204 (and hence the user 206) to provide additional information if the processor 214 determines that one or more scans may not be authenticate.

The description below describes an exemplary aspect where the system 200 transmits a scan order to the user device 204, and the user 206 scans barcodes associated with different vehicle components based on the scan order. The present disclosure is not limited to the system 200 transmitting a scan order to the user device 204, and then the user 206 scanning the barcodes. The user 206 may scan barcodes associated with different vehicle components in any order, without departing from the present disclosure scope.

In an exemplary aspect, the processor 214 may generate instructions/request for the user 206 to scan the QR codes/barcodes 108 in a specific order. The processor 214 may then transmit, via the transceiver 212, the generated instructions to the user device 204. For example, the processor 214 may transmit, via the transceiver 212, a first request to the user device 204 to scan a first barcode that may be disposed at a first vehicle component, as shown in view 305 of FIG. 3. Responsive to receiving the first request at the user device 204, the user 206 may scan the first barcode (and manually inspect the first vehicle component). The user device 204 may then transmit a first scan response (or first scan information) to the transceiver 212. 00511 The processor 214 may obtain, via the transceiver 212, the first scan response from the user device 204. Responsive to obtaining the first scan response, the processor 214 may authenticate the first scan response, as shown in view 310, or determine first scan authenticity by using instructions stored in the authentication module 226. In some aspects, the processor 214 may determine the first scan authenticity by determining or calculating a first authenticity score for the first scan response/information. Authentication process is described later in the description below.

Responsive to determining the first authenticity score, the processor 214 may compare the first authenticity score with a first threshold (that may be stored in the memory 216) The processor 214 may determine that the first scan response/information (and hence “first scan” for the first barcode) may be authentic when the first authenticity score is greater than the first threshold. On the other hand, the processor 214 may determine that the first scan response may not be authentic when the first authenticity score may be less than the first threshold.

Responsive to a determination that the first scan may not be authentic, the processor 214 may generate a second request/instructions to provide first additional information to confirm vehicle first component inspection, as shown in view 315. Stated another way, the processor 214 may generate the second request to receive the first additional information to confirm that the user 206 has actually inspected the vehicle first component. For example, the processor 214 may generate the second request to provide images (or any other form of input, e.g., audio) associated with the vehicle first component using the user device 204.

The processor 214 may transmit, via the transceiver 212, the second request to the user device 204. Responsive to receiving the second request on the user device 204, the user 206 may capture vehicle first component image(s) by using, e.g., user device 204 camera. The user device 204 may further transmit the captured vehicle first component image(s) to the transceiver 212. The processor 214 may obtain vehicle first component image(s) from the transceiver 212. The processor 214 may further determine image authenticity (e.g., checking if the image is associated with the vehicle first component), and may approve vehicle first component inspection based on image authenticity.

In further aspects, responsive to a determination that the first scan may be authentic (e.g., when the first authenticity score may be greater than the first threshold, or when the obtained vehicle first component image may be authentic), the processor 214 may generate a third request to scan a second barcode that may be disposed at a second vehicle component. The processor 214 may transmit, via the transceiver 212, the third request to the user device 204, as shown in view 320. Stated another way, the processor 214 may enable or request the user 206 to scan the second barcode when the processor 214 determines that the scan information associated with the first barcode may be authentic, thus enabling the user 206 to scan barcodes in a “predefined” order. In this manner, the user 206 may not skip scanning any barcode or inspecting any vehicle component, and may have to scan each barcode authentically before moving to next barcode.

Responsive to receiving the third request, the user 206 may scan the second barcode by using the user device 204. Then user 206 may then transmit a second scan response/information to the transceiver 212. The processor 214 may obtain the second scan response from the transceiver 212. Responsive to obtaining the second scan response, the processor 214 may authenticate the second scan response (by using the authentication module 226). In some aspects, the processor 214 may authenticate the second scan response by determining/calculating a second authenticity score for the second scan response.

Responsive to determining the second authenticity score, the processor 214 may compare the second authenticity score with a second threshold (that may be stored in the memory 216, the second threshold may be same or different from the first threshold). The processor 214 may determine that the second scan response (and hence scan for the second vehicle component) may not be authentic when the second authenticity score may be less than the second threshold. Responsive to a determination that the scan for the second vehicle component may not be authentic, the processor 214 may generate a fourth request to receive second additional information (e.g., a vehicle second component image) from the user device 204. The processor 214 may transmit, via the transceiver 212, the fourth request to the user device 204.

Responsive to receiving the fourth request, the user 206 may capture the vehicle second component image by using the user device 204 camera. The user 206 may further transmit the captured vehicle second component image to the transceiver 212. The processor 214 may obtain the vehicle second component image from the transceiver 212, and authenticate the vehicle second component image (i.e., the second additional information), as described above.

In further aspects, responsive to a determination that the second scan response may be authentic (or the second additional information may be authentic), the processor 214 may generate a fifth request to scan a third barcode and so on, and until all vehicle components may be inspected and corresponding barcodes scanned.

In additional aspects, the processor 214 may store the first scan response in the memory 216 (e.g., in the scan information database 218) when the first authenticity score may be greater than the first threshold, and may store the second scan response when the second authenticity score may be greater than the second threshold.

As described above, the processor 214 may determine, via the authentication module 226, authenticity for the first scan response and the second scan response to confirm that the user 206 may have actually inspected the vehicle first component and the vehicle second component. Exemplary embodiments or parameters used by the processor 214 to determine/calculate authentication scores (for the first scan response/information or the second scan response/information) are described below. The embodiments or parameters described below are for illustrative purpose, and should not be construed as limiting the present disclosure scope. The processor 214 may use any other process and/or parameters to determine authentication scores for barcode scans.

In some aspects, the processor 214 may use time stamp information associated with obtained scan information to calculate authentication scores. For example, the processor 214 may obtain, via the transceiver 212, time stamp of receiving the first scan response and the second scan response from the user device 204 at the transceiver 212. In some aspects, the processor 214/transceiver 212 may further store the obtained time stamp in the user device information database 220. The processor 214 may further determine a time gap between receiving the first scan response and the second scan response, and compare the time gap with a respective predetermined threshold value stored in the memory 216. Based on the comparison, the processor 214 may determine the second authenticity score associated with scan response/information of the second vehicle component.

For example, if the processor 214 receives the second scan response after 15 seconds of receiving the first scan response and the threshold is 10 second (e.g., a predetermined minimum time duration to move from the vehicle first component to the vehicle second component), the processor 214 may determine that the second authenticity score may be high (e.g., the second scan response may be authentic). Alternatively, if the processor 214 receives the second scan response within 3 seconds of receiving, the first scan response, the processor 214 may determine that the second authenticity score may be low (e.g., the second scan response may not be authentic).

In further aspects, the processor 214 may use user device 204 orientation to calculate authentication scores. For example, the processor 214 may obtain, via the transceiver 212, user device 204 orientation when the user 206 scans the first barcode and/or the second barcode by using the user device 204. In an exemplary aspect, the processor 214 may obtain the user device 204 orientation from an Inertial Measurement Unit (IMU) (or any other device) located in the user device 204. The processor 214/transceiver 212 may further store the obtained user device 204 orientation in the user device information database 220.

The processor 214 may calculate the first authenticity score and the second authenticity score by comparing the user device 204 orientation (while scanning the first barcode and the second barcode) with respective pre-stored orientations (or expected orientations) associated with the first barcode and the second barcode (e.g., based on location of the first barcode and the second barcode, stored in the memory 216). For example, the processor 214 may determine/calculate a low authentication score (e.g., 2 or 3 on a scale of 10) when the processor 214 determines that the user device 204 orientation may be directed towards the sky when the user 206 may be scanning the vehicle front tire. In this case, the expected user device 204 orientation may be “titled-downwards” towards the vehicle front tire, and hence a user device 204 orientation directed towards the sky may result in a low authentication score.

In yet another aspect, the processor 214 may use user device 204 location to calculate authentication scores. For example, the processor 214 may obtain, via the transceiver 212, user device 204 location when the user 206 scans the first barcode and/or the second barcode. In an exemplary aspect, the processor 214 or transceiver 212 may obtain the user device 204 location from Global Positioning System (GPS) transceiver associated with the user device 204. The processor 214 may determine whether the user device 204 is in proximity to the respective barcodes when the user 206 scans the respective barcode based on the location.

The processor 214 may calculate the first authenticity score and the second authenticity score by comparing the user device 204 location (while scanning the first barcode and/or the second barcode) with respective expected locations associated with the first barcode and/or the second barcode (or the vehicle 202). The processor 214 may further store the location in the user device information database 220. For example, the processor 214 may determine/calculate a low authentication score when the user device 204 location may be 25 meters away from the vehicle 202 location (and thus far from the first barcode and second barcode location) while the user 206 scans the first barcode and/or the second barcode. On the other hand, the processor 214 may calculate a high authentication score when the processor 214 determines that the user device 204 location may be in proximity to the vehicle first component or second component location when the user 206 scans the first barcode or the second barcode.

In a similar manner, the processor 214 may calculate additional authentication scores based on one or more additional parameters. Responsive to calculating individual authentication score for each parameter, the processor 214 may calculate a “final” first authentication score and/or a “final” second authentication score. In some aspects, the final authentication score may be a linear or a weighted average of individual authentication scores. In this case, weights associated with each parameter may be pre-stored in the memory 216. For example, if the weight associated with scan time gap parameter is 40%, the weight associated with user device 204 orientation is 20%, and the weight associated with user device 204 location is 40%, the processor 214 may calculate the final authentication score as 0.4*(time-gap based scan authentication score)+0.2*(user device orientation based scan authentication score)+0.4*(user device location based scan authentication score).

In further aspects, the processor 214 may be configured to determine scan authenticity based on historical user 206 responses. For example, the processor 214 may store the obtained first scan response and the second scan response associated with the user 206 in the operator information database 222, as “historical operator responses”. When the processor 214 obtains another scan response from the user device 204, the processor 214 may obtain the historical operator responses from the operator information database 222, and determine confidence level/score associated with the user 206 (e.g., whether the user 206 regularly performs authentic inspection). As an example, the processor 214 may determine a low confidence score (e.g., 40%), if 40% of obtained scan responses from the user device 204 are determined to be unauthentic by the processor 214, based on the historical operator responses. On the other hand, the processor 214 may determine a high confidence score (e.g., 80% or 90%), if 80% or 90% of obtained scan responses from the user device 204 are determined to be authentic by the processor 214, based on the historical operator responses.

In an exemplary aspect., the processor 214 use the determined confidence score as an input to calculate the final authentication score, as described above. For example, the processor 214 may calculate high authenticity score when the confidence level may be high, and may calculate low authenticity score when the confidence level may be low.

In additional aspects, the processor 214 may be configured to “remind” the user 206 to perform vehicle inspection before the user 206 commences a trip. For example, the processor 214 may use vehicle historical usage information to predict when the user 206 may be expected to commence a trip, and the processor 214 may transmit an inspection reminder to the user device 204 a predefined time duration before an expected trip commencement time. In this case, the processor 214 may obtain vehicle historical usage information from the historical usage information database 224, and may analyze the information to predict a vehicle trip commencement time based on the vehicle historical usage information. In some aspects, the processor 214 may transmit a request (e.g., the first request) to scan the first barcode a predefined time duration (e.g., 30 minutes) before the vehicle trip commencement time. Stated another way, the processor 214 may trigger vehicle inspection based on a predicted vehicle trip start time. For example, the processor 214 may determine that the user 206 typically starts a trip every Monday at 8 AM based on the vehicle historical usage information. Based on such determination, the processor 214 may transmit a trigger signal to the user device 204 to perform vehicle inspection on Monday morning at 7:30 AM. Responsive to receiving such trigger signal, the user 206 may initiate scanning the first barcode, the second barcode, etc., as described above.

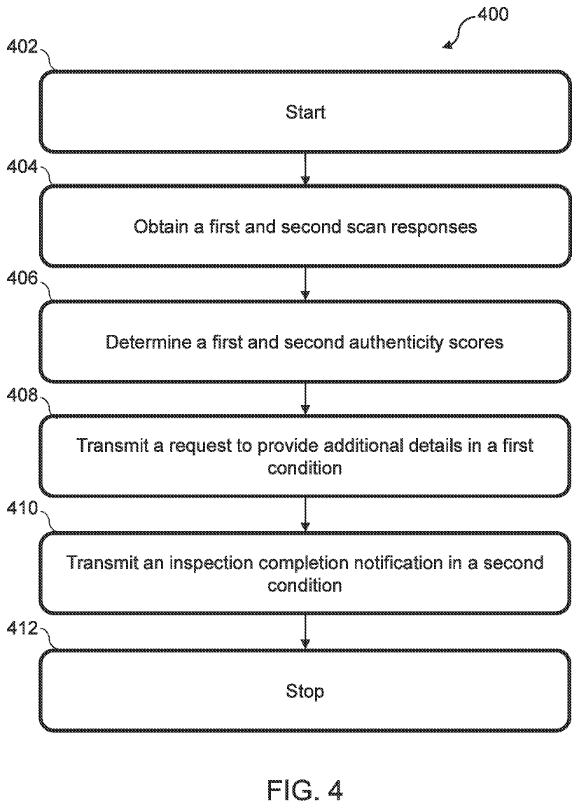

FIG. 4 depicts a flow diagram of an example first vehicle inspection method 400 in accordance with the present disclosure. FIG. 4 may be described with continued reference to prior figures, including FIGS. 1-3. The following process is exemplary and not confined to the steps described hereafter. Moreover, alternative embodiments may include more or less steps that are shown or described herein and may include these steps in a different order than the order described in the following example embodiments.

Referring to FIG. 4, at step 402, the method 400 may commence. At step 404, the method 400 may include obtaining, by the processor 214, a first scan response and a second scan response from a user device (e.g., the user device 204). The first scan response may be associated with scan of a first barcode disposed at (or in proximity to) a vehicle first component, and the second scan response may be associated with scan of a second barcode disposed at (or in proximity to) a vehicle second component.

At step 406, the method 400 may include determining, by the processor 214, a first authenticity score and a second authenticity score. The first authenticity score may be associated with first scan response authenticity and the second authenticity score may be associated with second scan response authenticity. The process of determining the authenticity score is already described above.

At step 408, the method 400 may include transmitting, by the processor 214, a request to provide additional details in a first condition. In particular, the processor 214 may compare the first authenticity score and the second authenticity score with respective threshold (e.g., first threshold and second threshold), and transmit the request when the first authenticity score or the second authenticity score is less than the threshold. For example, the processor 214 may request for a vehicle first component image when the first authenticity score is less than the first threshold, or a vehicle second component image when the second authenticity score is less than the second threshold. The first threshold and the second threshold may be same or different.

At step 410, the method 400 may include transmitting, by the processor 214, an inspection completion notification in a second condition. In particular, the processor 214 may compare the first authenticity score and the second authenticity score with respective threshold (e.g., first threshold and second threshold), and transmit the inspection completion notification when the first authenticity score and the second authenticity score are greater than the threshold.

The method 400 may stop at step 412.

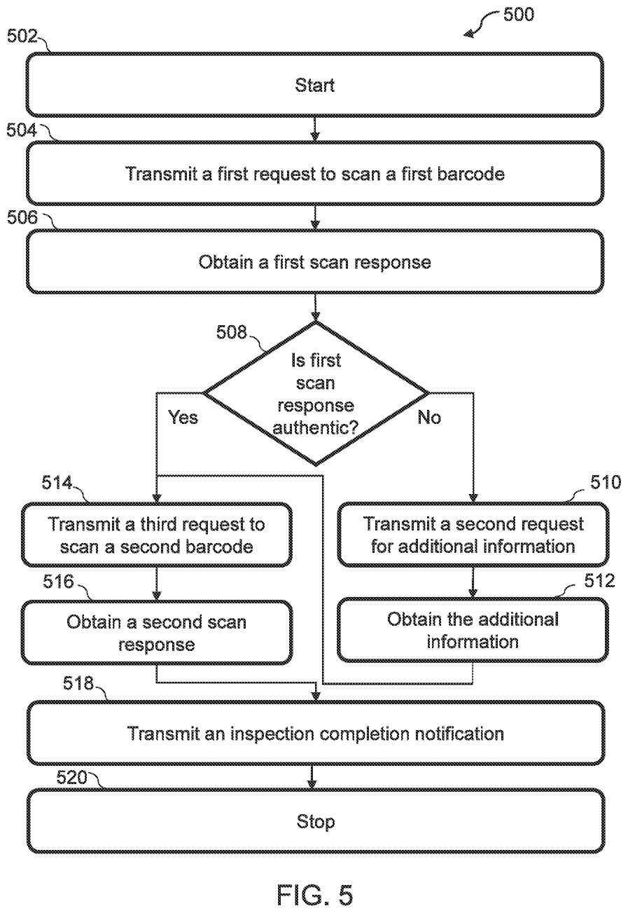

FIG. 5 depicts a flow diagram of an example second vehicle inspection method 500 in accordance with the present disclosure. FIG. 5 may be described with continued reference to prior figures, including FIGS. 1-4. The following process is exemplary and not confined to the steps described hereafter. Moreover, alternative embodiments may include more or less steps that are shown or described herein and may include these steps in a different order than the order described in the following example embodiments.

Referring to FIG. 5, at step 502, the method 500 may commence. At step 504, the method 500 may include transmitting, by the processor 214, a first request to the user device 204 to scan a first barcode disposed at (or in proximity to) a vehicle first component. At step 506, the method 500 may include obtaining, by the processor 214, a first scan response responsive to transmitting the first request.

At step 508, the method 500 may include determining, by the processor 214, whether the first scan response may be authentic, as described in conjunction with FIG. 2. In some aspects, at the step 508, the processor 214 may determine a first authenticity score for the first scan response, and compare the first authenticity score with a first threshold. The processor 214 may determine that the first scan response may be authentic when the first authenticity score may be greater than the first threshold. On the other hand, the processor 214 may determine that the first scan response may not be authentic when the first authenticity score may be less than the first threshold. The process of determining the authenticity score is already described above.

Responsive to a determination that the first scan response may not be authentic, the method 500 moves to step 510. At step 510, the method 500 may include transmitting, by the processor 214, a second request to the user device 204 to provide additional information to confirm vehicle first component inspection. For example, the processor 214 may send the second request to the user device 204 to provide a vehicle first component image (e.g., a fuel system image) when the processor 214 determines that the scan associated with the barcode of fuel system may not be authentic. At step 512, the method 500 may include obtaining, by the processor 214, the additional information (e.g., the vehicle first component image) responsive to transmitting the second request. In some aspects, the processor 214 may additionally confirm additional information authenticity, as described above. The method 500 may move to step 514 after the step 512.

In further aspects, responsive to a determination that the first scan response may be authentic at the step 508, the method 500 moves to step 514. At step 514, the method 500 may include transmitting, by the processor 214, a third request to the user device 204 to scan a second barcode disposed at (or in proximity to) a vehicle second component. At step 516, the method 500 may include obtaining, by the processor 214, a second scan response responsive to transmitting the third request. In some aspects, the processor 214 may further determine second scan response authenticity like the first scan response authenticity, and may request for second additional information associated with the vehicle second component when the second scan response authenticity is below a second threshold. The processor 214 may further store the first scan response and the second scan response when the first scan response and the second scan response are determined to be authentic. The processor 214 may store the scan responses in the memory 216 and/or the server 210.

At step 518, the method 500 may include transmitting, by the processor 214, an inspection completion request to the user device 204 when the processor 214 obtains the second scan response. In some aspects, the processor 214 may transmit the inspection completion request to the user device 204 when the processor 214 determines that the second scan response may be authentic.

At step 520, the method 500 may stop.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments nay not include, certain features, elements, and/or steps. Thus, such conditional language is not generally intended to imply that features, elements, and/or steps are in any way required for one or more embodiments.

That which is claimed is:

1. A method to facilitate vehicle inspection comprising:
obtaining, by a processor, first scan information and second scan information from a user device, wherein the first scan information is associated with a first barcode disposed at a vehicle first component and the second scan information is associated with a second barcode disposed at a vehicle second component, and wherein the user device is configured to scan the first barcode and the second barcode,
determining, by the processor, a first authenticity score for the first scan information and a second authenticity score for the second scan information:
transmitting, by the processor, a request to the user device to provide additional information when the first authenticity score or the second authenticity score is less than a threshold; and
transmitting, by the processor, an inspection completion notification to the user device when the first authenticity score and the second authenticity score are greater than the threshold.

2. The method of claim 1, wherein obtaining the first scan information and the second scan information comprising obtaining the first scan information and the second scan information in a sequence.

3. The method of claim 1 further comprising:
determining a time gap between obtaining the first scan information and obtaining the second scan information; and
determining the second authenticity score based on the time gap.

4. The method of claim 1 further comprising:
obtaining a user device orientation when the user device scans the first barcode and the second barcode:
determining the first authenticity score based on the user device orientation when the user device scans the first barcode; and
determining the second authenticity score based on the user device orientation when the user device scans the second barcode.

5. The method of claim 1 further comprising:
obtaining a user device location when the user device scans the first barcode and the second barcode;
determining the first authenticity score based on the user device location when the user device scans the first barcode; and
determining the second authenticity score based on the user device location when the user device scans the second barcode.

6. The method of claim 1, wherein the additional information comprises a vehicle first component image when the first authenticity score is less than the threshold, and wherein the additional information comprises a vehicle second component image when the second authenticity score is less than the threshold.

7. The method of claim 1 further comprising:
obtaining the additional information responsive to transmitting the request.

8. The method of claim 1 further comprising:
obtaining historical scan responses associated with the user device;
determining a confidence level of a user associated with the user device based on the historical scan responses; and
determining the first authenticity score and the second authenticity score based on the confidence level.

9. The method of claim 1 further comprising:
obtaining historical usage information associated with a vehicle;
determining a trip start time based on the historical usage information; and
transmitting a trigger signal to the user device to provide the first scan information and the second scan information before the trip start time.

10. A system to facilitate vehicle inspection comprising:
a transceiver configured to receive first scan information and second scan information from a user device, wherein the first scan information is associated with a first barcode disposed at a vehicle first component and the second scan information is associated with a second barcode disposed at a vehicle second component, and wherein the user device is configured to scan the first barcode and the second barcode; and
a processor communicatively coupled to the transceiver, wherein the processor is configured to:
obtain the first scan information and the second scan information from the transceiver;
determine a first authenticity score for the first scan information and a second authenticity score for the second scan information;
transmit a request to the user device to provide additional information when the first authenticity score or the second authenticity score is less than a threshold; and
transmit an inspection completion notification to the user device when the first authenticity score and the second authenticity score are greater than the threshold.

11. The system of claim 10, wherein the processor is configured to obtain the first scan information and the second scan information in a sequence.

12. The system of claim 10, wherein the processor is further configured to:
determine a time gap between receiving the first scan information and the second scan information; and
determine the second authenticity score based on the time gap.

13. The system of claim 10, wherein the processor is further configured to:
obtain a user device orientation when the user device scans the first barcode and the second barcode;
determine the first authenticity score based on the user device orientation when the user device scans the first barcode; and
determine the second authenticity score based on the user device orientation when the user device scans the second barcode.

14. The system of claim 10, wherein the processor is further configured to:
obtain a user device location when the user device scans the first barcode and the second barcode;
determine the first authenticity score based on the user device location when the user device scans the first barcode; and
determine the second authenticity score based on the user device location when the user device scans the second barcode.

15. The system of claim 10, wherein the additional information comprises a vehicle first component image when the first authenticity score is less than the threshold, and wherein the additional information comprises a vehicle second component image when the second authenticity score is less than the threshold.

16. The system of claim 10, wherein the processor is further configured to obtain the additional information responsive to transmitting the request.

17. The system of claim 10, wherein the processor is further configured to:
obtain historical scan responses associated with the user device;
determine a confidence level of a user associated with the user device based on the historical scan responses; and
determine the first authenticity score and the second authenticity score based on the confidence level.

18. The system of claim 10, wherein the processor is further configured to:
obtain historical usage information associated with a vehicle;
determine a trip start time based on the historical usage information; and
transmit a trigger signal to the user device to provide the first scan information and the second scan information before the trip start time.

19. The system of claim 10, wherein the first vehicle component is located in proximity to the second vehicle component.

20. A non-transitory computer-readable storage medium having instructions stored thereupon which, when executed by a processor, cause the processor to:
obtain first scan information and second scan information from a user device, wherein the first scan information is associated with a first barcode disposed at a vehicle first component and the second scan information is associated with a second barcode disposed at a vehicle second component, and wherein the user device is configured to scan the first barcode and the second barcode;
determine a first authenticity score for the first scan information and a second authenticity score for the second scan information;
transmit a request to the user device to provide additional information when the first authenticity score or the second authenticity score is less than a threshold; and
transmit an inspection completion notification to the user device when the first authenticity score and the second authenticity score are greater than the threshold.
